(19) United States
(12) Patent Application Publication
(10) Pub. No.: US 2018/0230024 A1
(43) Pub. Date: Aug. 16, 2018

(54) HIGH TOXICITY WASTEWATER MITIGATION METHODS AND SYSTEMS

(71) Applicant: Casey Glynn, Boston, MA (US)

(72) Inventor: Casey Glynn, Boston, MA (US)

(21) Appl. No.: 15/891,943

(22) Filed: Feb. 8, 2018

Related U.S. Application Data
(60) Provisional application No. 62/456,435, filed on Feb. 8, 2017.

(51) Int. Cl. C02F 1/44; B01D 61/02; B01D 61/14; C02F 1/58; C02F 9/00; E21B 43/26; E21B 43/34

(52) U.S. Cl. CPC C02F 1/441; C02F 2101/32; B01D 61/025; B01D 61/147; C02F 1/58; C02F 9/005; E21B 43/26; E21B 43/34; B01D 2221/04; B01D 2257/702; B01D 2257/91; B01D 2311/14; B01D 2311/20; B01D 2311/246; B01D 2311/2619; B01D 2313/243; B01D 61/022

(57) ABSTRACT

Methods and systems for reducing contaminants and dissolved solids in wastewater produced by hydraulic fracturing operations using multiple reverse osmosis membrane stages.

### CROSS REFERENCE TO RELATED APPLICATION

This application claims priority from U.S. Provisional Patent Application No. 62/456,435 filed on Feb. 8, 2017 entitled METHODS AND SYSTEMS FOR TREATING FRACKING WASTEWATER, which is hereby incorporated by reference.

### BACKGROUND

The present application relates generally to treatment of wastewater and, more particularly, to methods and systems for purifying and recovering high toxicity wastewater including, e.g., wastewater produced by hydraulic fracturing (fracking) and other operations.

Fracking is a drilling process used to extract oil and natural gas from rock formations. The process involves pumping water down a wellhead at a pressure sufficient to penetrate underground formations, which results in the release of materials such as hydrocarbons, suspended solids, and dissolved solids. When the fracking operation is complete, the pressure is released, and some of the water flows back up the wellhead and is captured as fracking wastewater. The wastewater is typically contaminated with hydrocarbons, suspended solids, dissolved solids, metals, bacteria, and/or other contaminants. The wastewater must be treated before it can be released into the environment or reused in the fracking process.

### BRIEF SUMMARY OF THE DISCLOSURE

In accordance with one or more further embodiments, a system is disclosed for reducing contaminants and dissolved solids in wastewater produced by hydraulic fracturing operations. The system includes a tank for receiving the wastewater from a wastewater source and mixing the wastewater with a stream of water having a lower level of total dissolved solids than the wastewater to produce a stream of diluted wastewater. Multiple reverse osmosis stages are provided for processing the stream of diluted wastewater including a first reverse osmosis stage connected in series to a second reverse osmosis stage, wherein the first reverse osmosis stage produces a first brine stream and a first permeate stream. The first brine stream is output as waste when the first brine stream reaches a given concentration of total dissolved solids, and the first permeate stream is output to the second reverse osmosis stage. The second reverse osmosis stage produces a second brine stream and a second permeate stream, wherein a portion of the second permeate stream is provided to the tank to dilute additional wastewater to be processed and the remainder of the second permeate stream is output as permeate, and wherein the second brine stream is provided to the tank to be mixed with the additional wastewater. The system further includes connection lines for operably connecting the tank and the reverse osmosis stages. The system also includes a pump system for pumping liquid streams among the tank and the reverse osmosis stages.

In accordance with one or more embodiments, a method is disclosed for reducing contaminants and dissolved solids in wastewater produced by hydraulic fracturing operations. The method includes the steps of: receiving the wastewater from a wastewater source; mixing, in a tank, the wastewater with a stream of water having a lower level of total dissolved solids than the wastewater to produce a stream of diluted wastewater; processing the stream of diluted wastewater in series in multiple reverse osmosis stages including a first reverse osmosis stage and a second reverse osmosis stage, wherein the first reverse osmosis stage produces a first brine stream and a first permeate stream, wherein the method further comprises outputting the first brine stream as waste when the first brine stream reaches a given concentration of total dissolved solids, and outputting the first permeate stream to the second reverse osmosis stage; wherein the second reverse osmosis stage produces a second brine stream and a second permeate stream, wherein the method further comprises outputting a portion of the second permeate stream to the tank to dilute additional wastewater to be processed and outputting the remainder of the second permeate stream as permeate, and outputting the second brine stream to the tank to be mixed with the additional wastewater.

### BRIEF DESCRIPTION OF THE DRAWINGS

FIGS. 1A, 1B, and 1C (collectively referred to as FIG. 1) are perspective, top, and side views, respectively, of an exemplary fracking wastewater treatment system in accordance with one or more embodiments.

FIG. 2 is a simplified flow diagram illustrating an exemplary operation of the fracking wastewater treatment system of FIG. 1.

FIG. 3 is a table illustrating one example of purification results obtained using the fracking wastewater treatment system of FIG. 1.

FIG. 4 is a schematic diagram illustrating operation of a variable frequency drive sub-system for pumps and motors in the fracking wastewater treatment systems in accordance with one a more embodiments.

FIG. 5 is a perspective view of another exemplary fracking wastewater treatment system in accordance with one or more embodiments.

FIG. 6 is a simplified flow diagram illustrating an exemplary operation of the fracking wastewater treatment system of FIG. 5 in accordance with one or more embodiments.

FIG. 7 is a flow diagram illustrating an exemplary operation of the fracking wastewater treatment system of FIG. 5 showing an example of purification rates in accordance with one or more embodiments.

### DETAILED DESCRIPTION

Various embodiments disclosed herein relate to treatment of wastewater and, more particularly, to methods and systems for purifying and recovering high toxicity wastewater. While the various examples disclosed herein relate to treating fracking wastewater, the methods and systems in accordance with various embodiments are also usable with other types of wastewater including, but not limited to, generally any high salinity wastewater, lechate wastewater from landfills, industrial non-radiologic high toxicity wastewater, wastewater from coal or potash extraction, septic/sewage wastewater, wastewater produced from various mining operations, wastewater produced from oil and/or gas extraction processes, and wastewater produced from pharmaceutical and industrial processes.

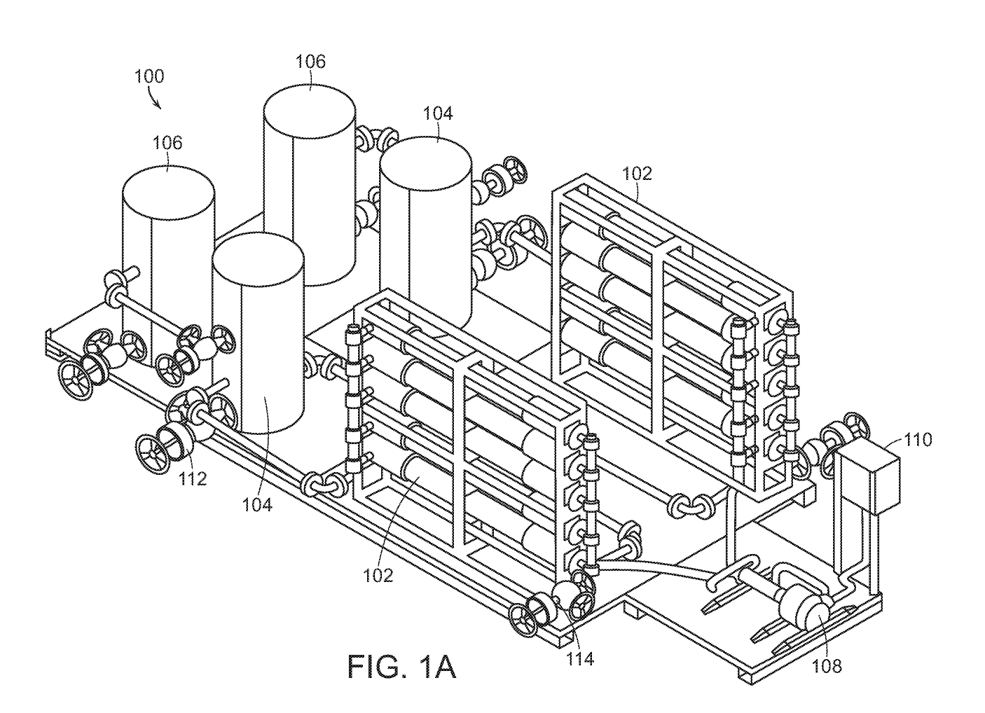

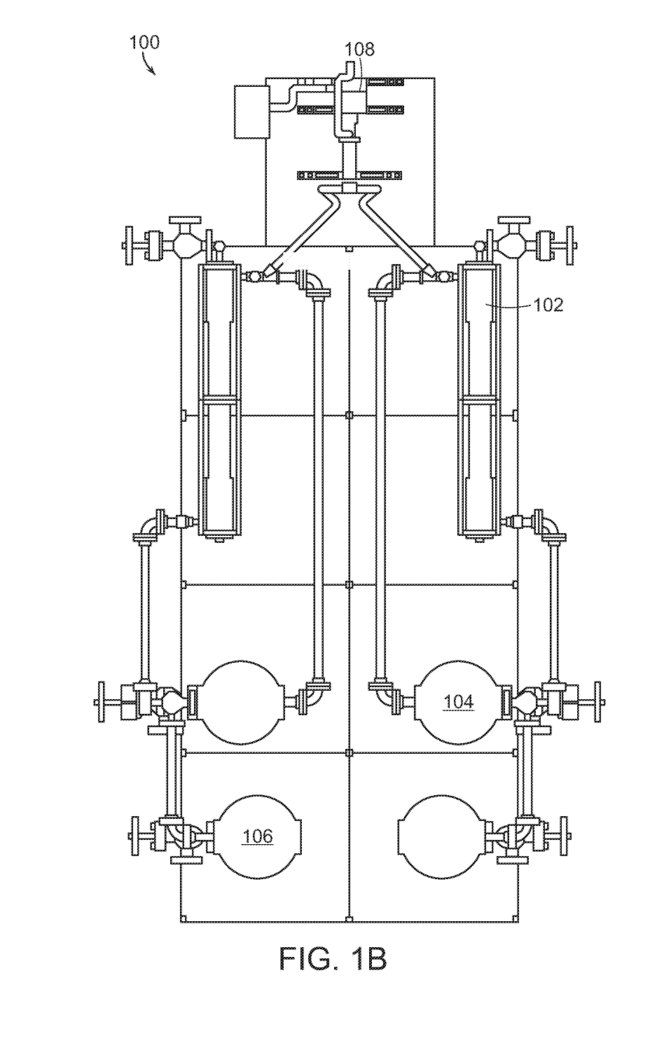

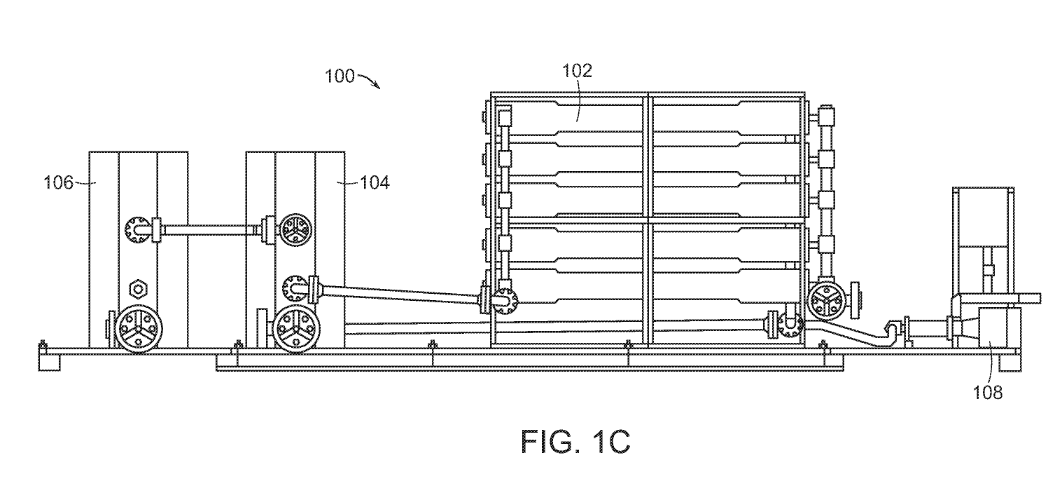

FIG. 1 illustrates an exemplary fracking wastewater treatment system 100 in accordance with one or more embodiments. The system 100 processes wastewater at a fracking site to produce three outputs: potable water, gray water, and brine. The potable water recovered from the wastewater can be safely released to the environment or reused in the wastewater treatment operation as will be described below.

The system 100 can operate independently or be an add-on to current fracking water treatment systems at fracking sites. In accordance with one or more embodiments, the system 100 is connected directly to waste storage tanks or bypass wastewater lines at a fracking site by any suitable connection apparatus (e.g., fasteners, threaded pipe, solvent welding, mechanical sleeve fittings, pressed fittings, and flanged fittings).

The system 100 includes multiple reverse osmosis (RO) membrane units 102 used to separate liquids from dissolved and suspended solids, in this case for removing contaminants and dissolved solids from fracking wastewater.

The system also includes concentration tanks 104, which receive the wastewater to be treated containing high levels of total dissolved solids (TDS). The concentration tanks 104 are used to control maximum salt load timing, as well as to provide TDS control.

The system also includes low TDS fluid feed tanks 106 holding water containing low levels of TDS used to dilute incoming high TDs fluid for purification as will be described further below.

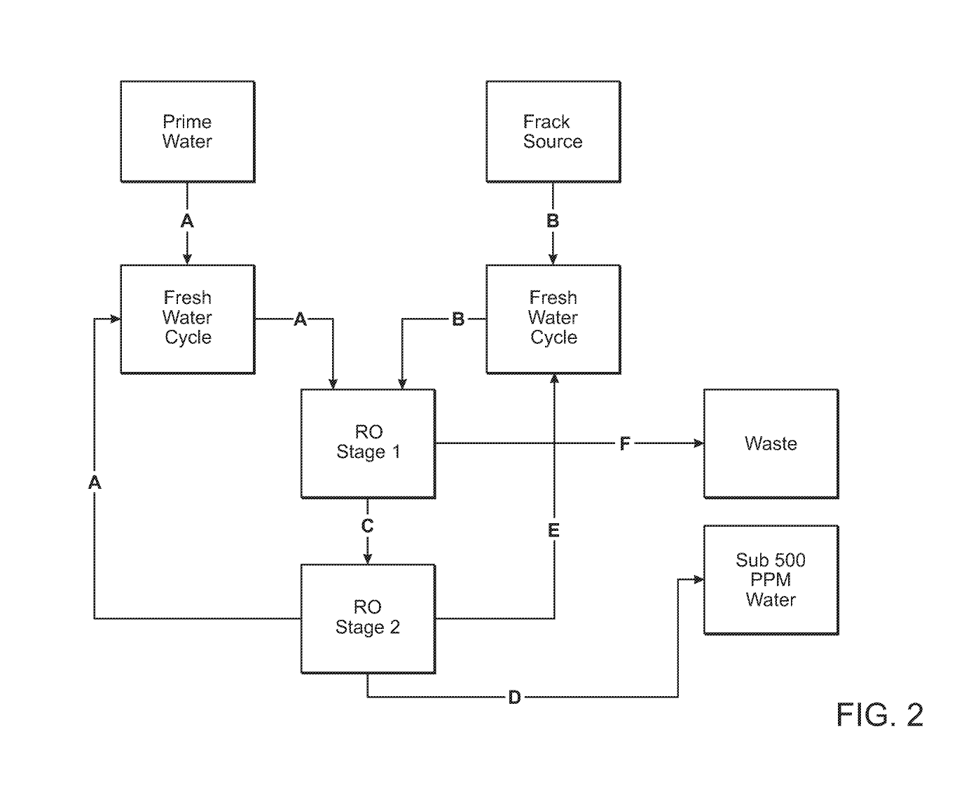

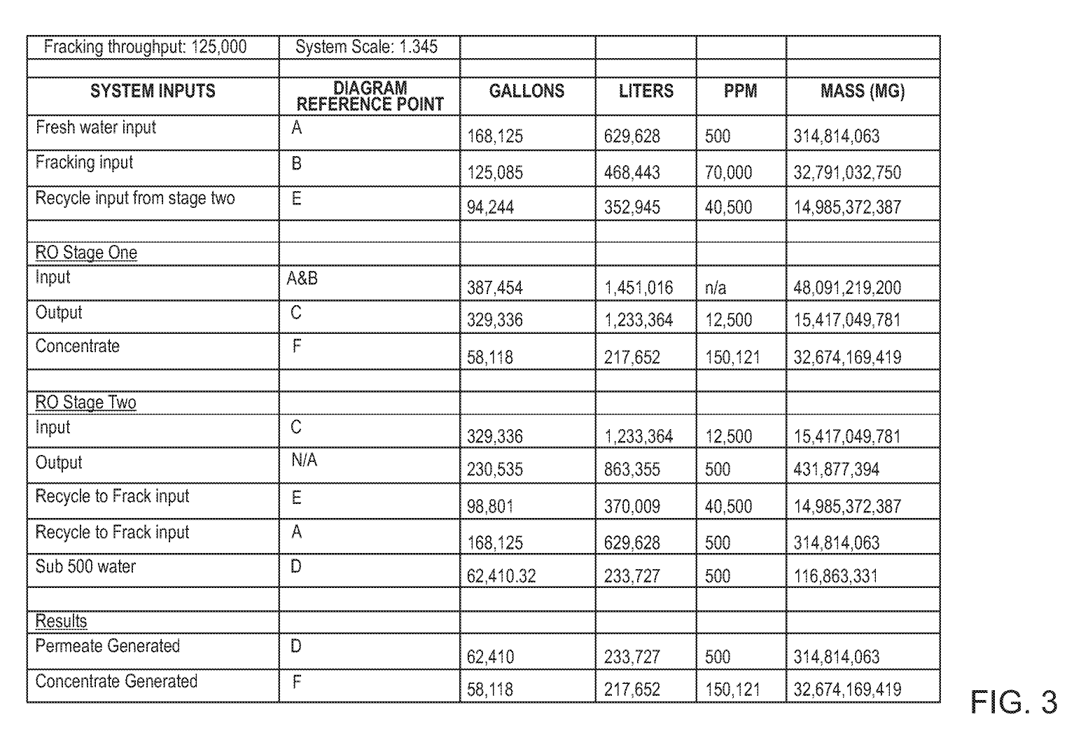

The concentration tanks 104, the low TDS fluid feed tanks 106, and the reverse osmosis units 102 are connected by various connection lines as depicted in FIGS. 1 and 2. A primary pump system 108 is used to pressurize the fluid flowing through the system.

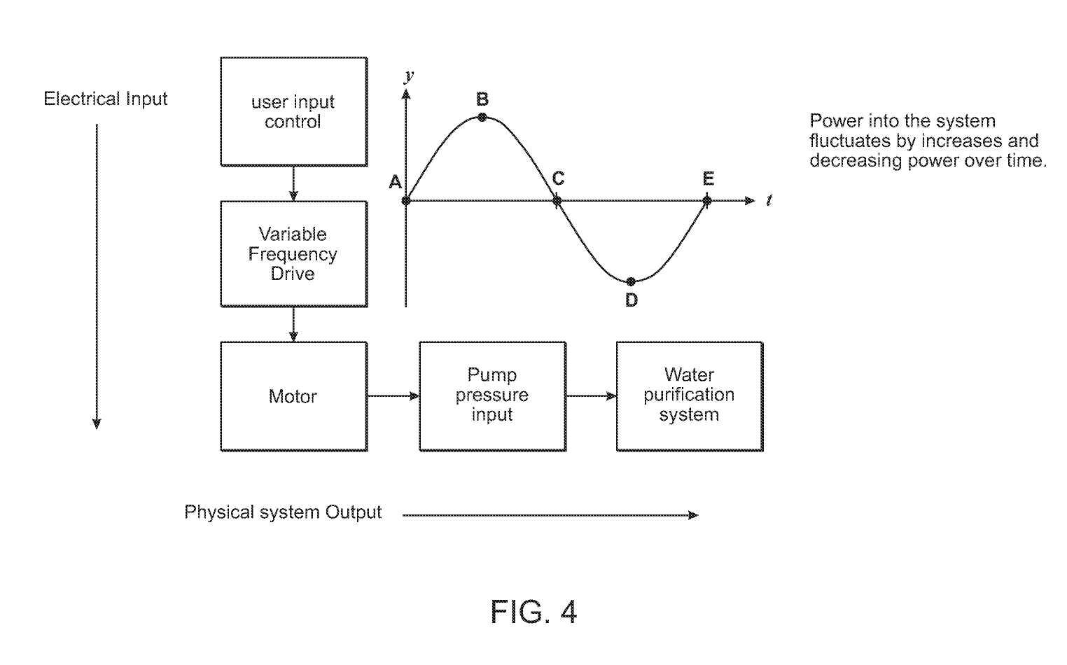

The system also includes a wave AI control panel 110, which is used to display system information and enable manual input for parameter changes. The wave AI system monitors and adjusts the system parameters for optimal efficiencies. The system can monitor various conditions and aspects of the system including, but not limited to, pressure, flow rate, conductivity, permeate flux, brine build up, and backwashing operations. It accomplishes this by reading real-time feedback from in-line sensors and adjusting mechanical components, such as the Variable Frequency Drive (VFD) for the revolutions per minute (RPM) speed of the motor, which increases or decreases flow, as well as motorized ball valves that control internal pressure. Further details of the system are provided below in connection with FIG. 4. This system can also be adjusted manually on-site or via cloud-based feedback. This system also includes the foundation for machine-learning to optimize operational parameters when processing user data.

In accordance with one or more embodiments, the TDS levels in the brine and permeate outputs can be adjusted as desired to meet particular needs by modulating the pressure in the system, and by varying the water concentration in the system by modulating the dilution level, before the concentrate/brine wastewater is removed from the system. This is controlled by programming the Wave AI system to meet particular use specifications. The system is configured to automatically adjust itself using the Wave AI to maintain the desired levels once initially programmed.

Brine wastewater TDS can also be controlled by the number of loops in the system. For example, if the water starts at 1,000 ppm TDS, it increases by 10% each loop the water takes within the system, so after the first loop, the TDS would be 1,100 ppm. Through this, the system can generate whatever brine wastewater concentration level is desired. For example, the system can concentrate the brine wastewater to a high enough TDS level to allow for the use/attachment to the system of a secondary element extraction technology to enable removal of various elements in the brine including, e.g., salt, Lithium, and other commoditizable elements. This can also be programmed and controlled by the Wave AI system.

The system outputs brine at a brine port 112, and outputs permeate at a permeate port 114.

The system 100 processes the fracking wastewater in multiple RO stages 102 to remove contaminants and dissolved solids. As illustrated in the FIG. 2 flow diagram, the concentration tank 104 is initially filled with priming low TDS water. The tank 104 is ordinarily only primed to start the cycle; once the cycle starts no additional low TDS water is needed as input. The fracking wastewater from the fracking source is slowly blended with the low TDS water in a recycling loop in the concentration tank 104. The primary pump system 108 sends pressurized water into the reverse osmosis membrane units 102 and a looping cycle. The membranes separate the water from contaminants and dissolved solids via reverse osmosis. The permeate water is first sent to fill the low TDS fluid feed tanks 106 for use in the next cycle. Once the requirement for the next cycle is met, the remaining permeate is then outputted from the system through permeate output 114. The pumping system 108 then adds fracking water in the system to maintain pressure and flow. This cycle keeps adding fracking water in until a maximum concentration point is reached. At this point the system releases the brine out of the brine port 112 and restarts the cycle. Additional RO systems can be linked in series to increase flow or decrease product water TDS levels as desired.

The wastewater that was not recovered by the reverse osmosis stages is rejected from the system by brine port 112 as a highly concentrated brine. This wastewater can be processed in an evaporator to remove the water, producing a near zero liquid waste for chemical recapture. When set up in a one stage configuration, the system will output gray-brackish water levels after a one stage reverse osmosis section. This water can be further purified by linking systems in series.

FIG. 3 illustrates one example of purification results obtained from exemplary operation of the fracking wastewater treatment system of FIG. 1. The lettered diagram reference points in the table correspond to the reference points shown in FIG. 2.

By way of example, fracking wastewater can have a TDS concentration above 45,000 PPM. In the FIG. 3 example the fracking wastewater has a TDS concentration of 70,000 PPM. Also in the FIG. 3 example, the permeate output by the system and used to dilute incoming wastewater comprises potable water having a TDS concentration of 500 PPM. In the FIG. 3 example, the brine output as waste has a TDS concentration of about 150,000. These values are provided as examples only and can vary based on the wastewater to be treated and varied system configurations and settings.

In accordance with one or more embodiments, the system is designed to be rapidly deployable at a fracking site.

FIG. 4 schematically illustrates operation of a variable frequency drive sub-system for pumps and motors in the system 100 in accordance with one a more embodiments. This sub-system can control the efficiency and power consumption of the motors and pumps in the system 100 to create an environment that will provide for low-power intake and maximum pressure output. The variable frequency drive's programming is adjusted to compensate for user input. The variable frequency drive controls motor output by modifying the electrical input into the motor's output. The system can vary the variable drive's output to increase and/or decrease motor output in accordance with users' desired parameters. The sub-system can be incorporated in every pump and motor configuration in the system 100.

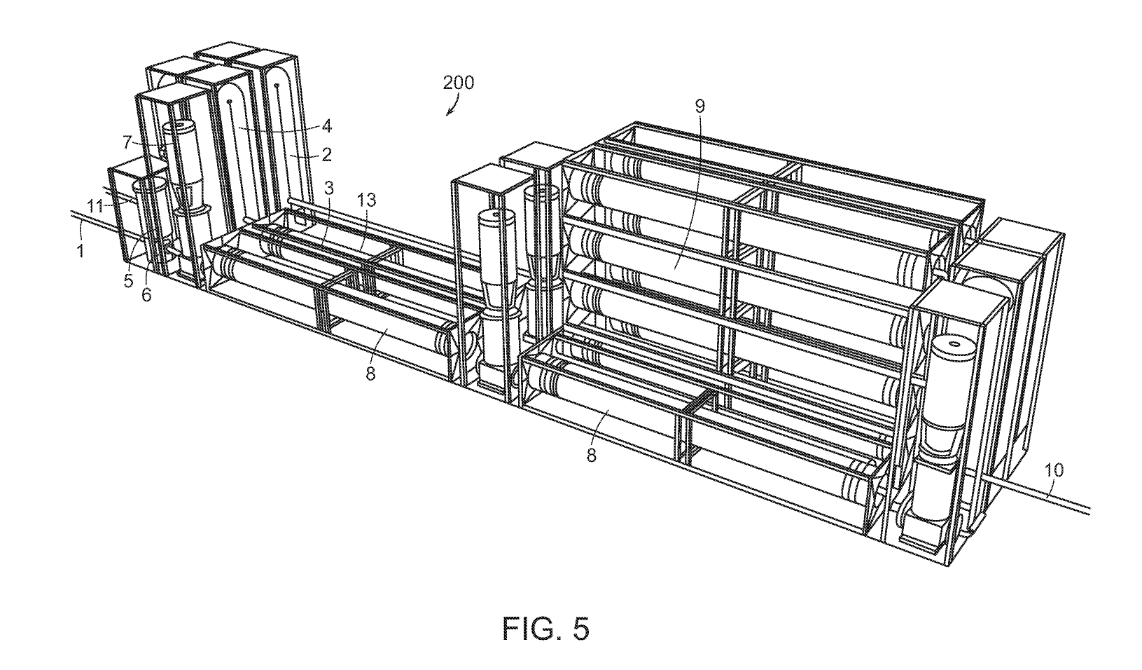

FIG. 5 illustrates an alternate exemplary fracking wastewater treatment system 200 in accordance with one or more embodiments. The system 200 processes wastewater at a fracking site to produce three outputs: potable water, gray water, and brine. A portion of the wastewater is recovered as potable water, which can be safely released to the environment or reused in the wastewater treatment operation as will be described below.

The system 200 can operate independently or be an add-on to current fracking water treatment systems at fracking sites. In accordance with one or more embodiments, the system 200 is connected directly to waste storage tanks or bypass wastewater lines at a fracking site by any suitable connection apparatus (e.g., fasteners, threaded pipe, solvent welding, mechanical sleeve fittings, pressed fittings, and flanged fittings). In the FIG. 5 embodiment, the system receives fracking wastewater from a wastewater pipe 1 connected thereto at the fracking site.

The system 200 processes the fracking wastewater in multiple stages to remove contaminants and dissolved solids. In the first stage, the wastewater, which contains high levels of total dissolved solids (TDS), is diluted with water containing low levels of TDS inside a mixing tank 4. The water containing low levels of TDS can be potable water provided to the system or recovered by the system and provided from tank 2, which receives the low TDS water through pipe 3 from a polishing step RO (described below). It is also possible to use gray water recovered by the system 200 to dilute the fracking wastewater depending on the TDS level of the wastewater. Gray water can be used if low TDS water is not available, but this will lower the efficiency of the system. The goal of the dilution step is to decrease the input wastewater's TDS level as much as possible. The ratio of the low TDS water stream to the high TDS water stream is based on the contamination and dissolved solids levels of both streams.

The second stage filters and decontaminates the diluted wastewater to protect equipment used in subsequent stages. The diluted wastewater mixed in tank 4 is flowed through filters 5 to remove suspended particles and subjected to a UVC (ultraviolet) pretreatment disinfection process 6. This stage can also include other filtration/decontamination equipment such as, e.g., settling tanks and chemical addition tanks.

Water from the second filtration/decontamination stage is pumped by a high-pressure pump 7 to the third stage, which is a reverse osmosis (RO) purification stage. This stage uses two levels of RO purification. The first RO stage 8 uses low salt rejection membranes, which act as a pre-filter to a second RO stage 9. These membranes allow a percentage of incoming ions and dissolved solids through to the permeate side of the RO system. This acts as “flow control” for contamination and dissolved solids. By controlling the dissolved solid content, the system directs a capped amount of dissolved solids that can be in one water stream, which enables the second-high recovery RO stage 9 to work optimally.

The second RO stage 9 removes the lingering ions and dissolved solids from the water. The second RO stage 9 re-pressurizes the water and then filters the water through a high recovery reverse osmosis system. All RO stages can use pressure exchangers to reduce power consumption.

The system has three outputs: potable water, gray water, and brine. The wastewater that was not recovered by RO is rejected from the system through pipe 10 as brine. This water has significantly reduced contamination, ions, and dissolved solids, but does not meet gray water standards. The second output is gray water, which comes directly from the second RO stage 9 through pipe 12. This water has been stripped of most chemicals and dissolved solids (dissolved solid reduction of 40% or higher can be obtained). This water can be further cleaned by using a RO polishing stage 13, which uses a low-pressure motor to cycle water through a RO set-up to produce potable water. This water can be used for low TDS applications through pipe 11 or to be recycled back in to the low TDS water system.

In accordance with one or more embodiments, the system is designed to be rapidly deployed at a fracking site.

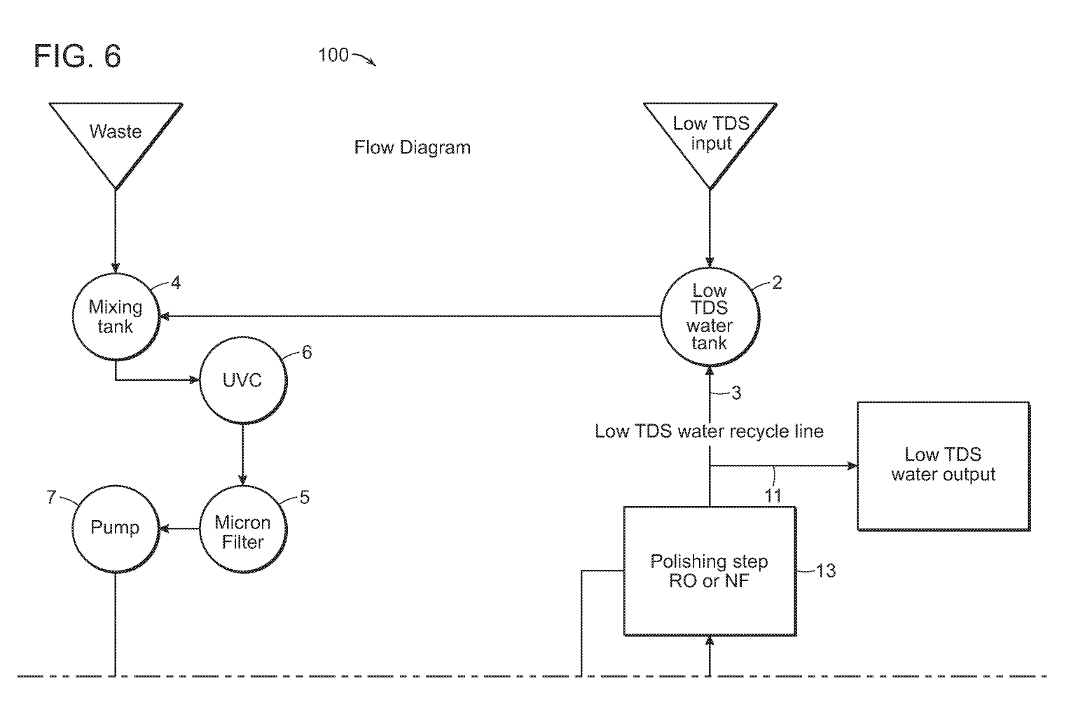

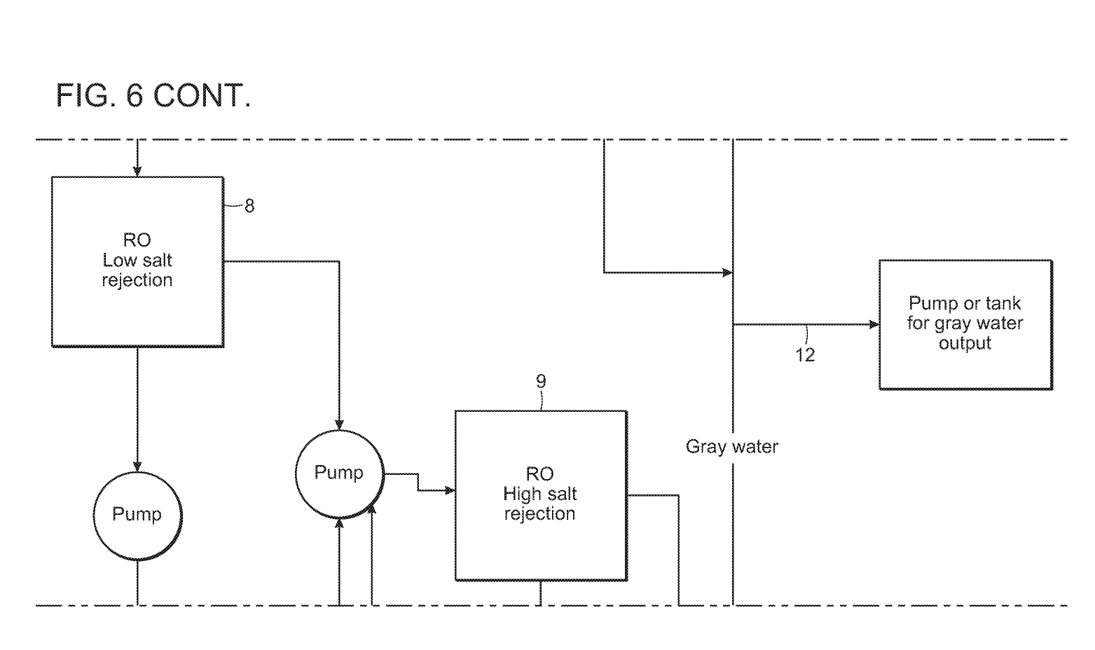

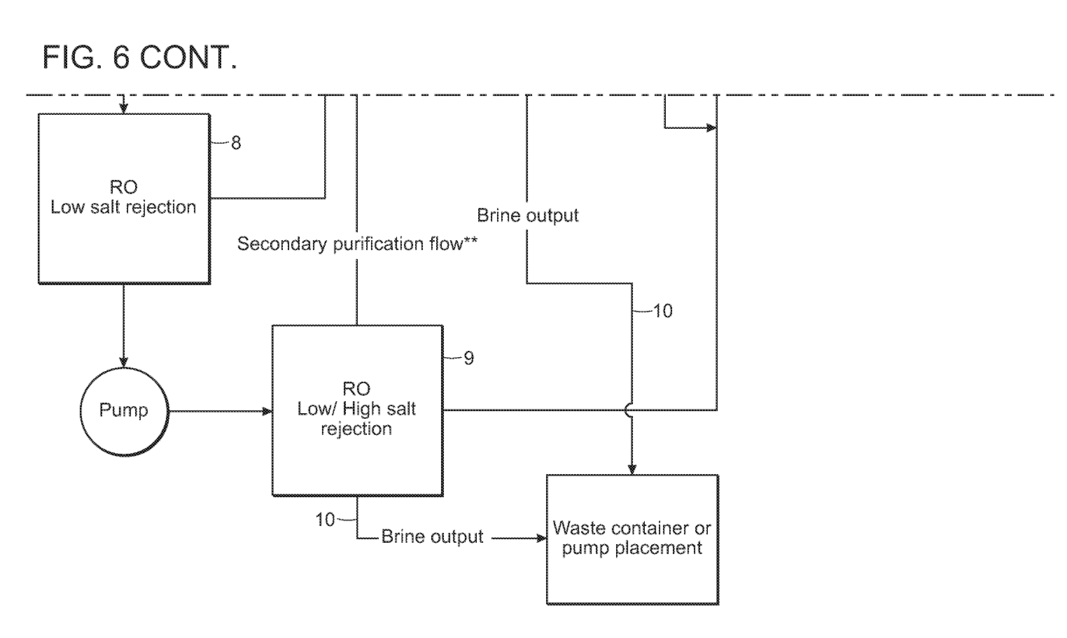

FIG. 6 is a flow diagram further illustrating operation of the system 200 in accordance with one or more embodiments.

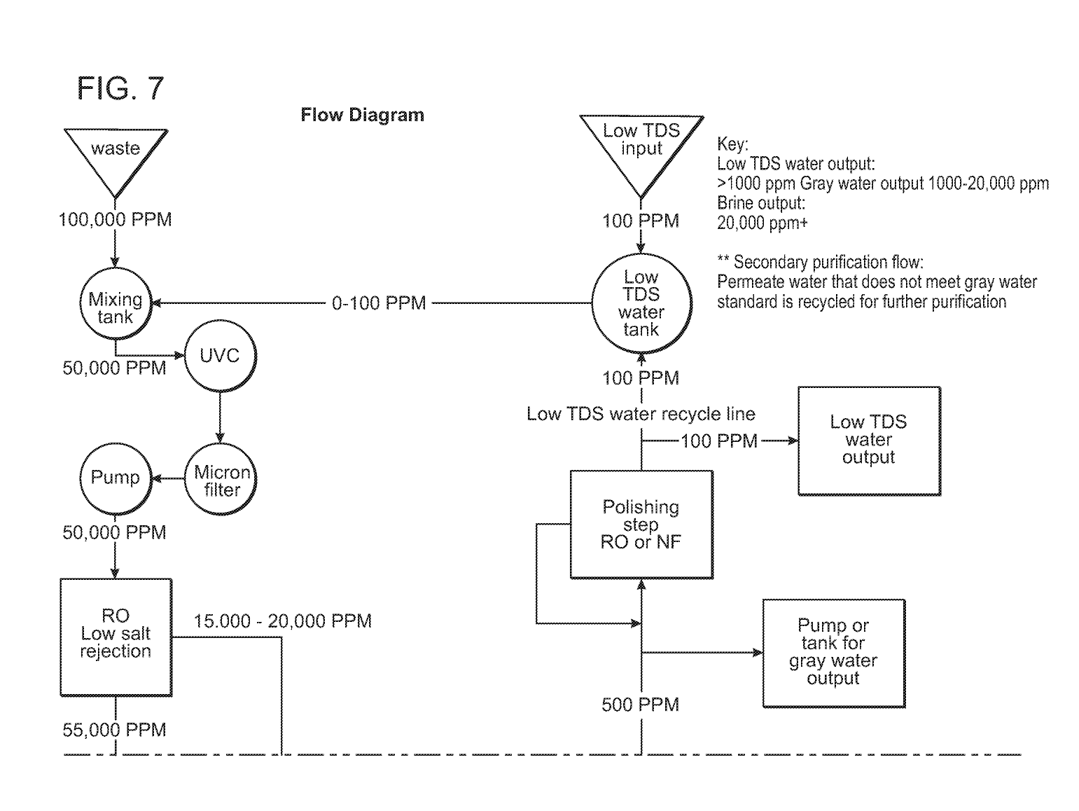

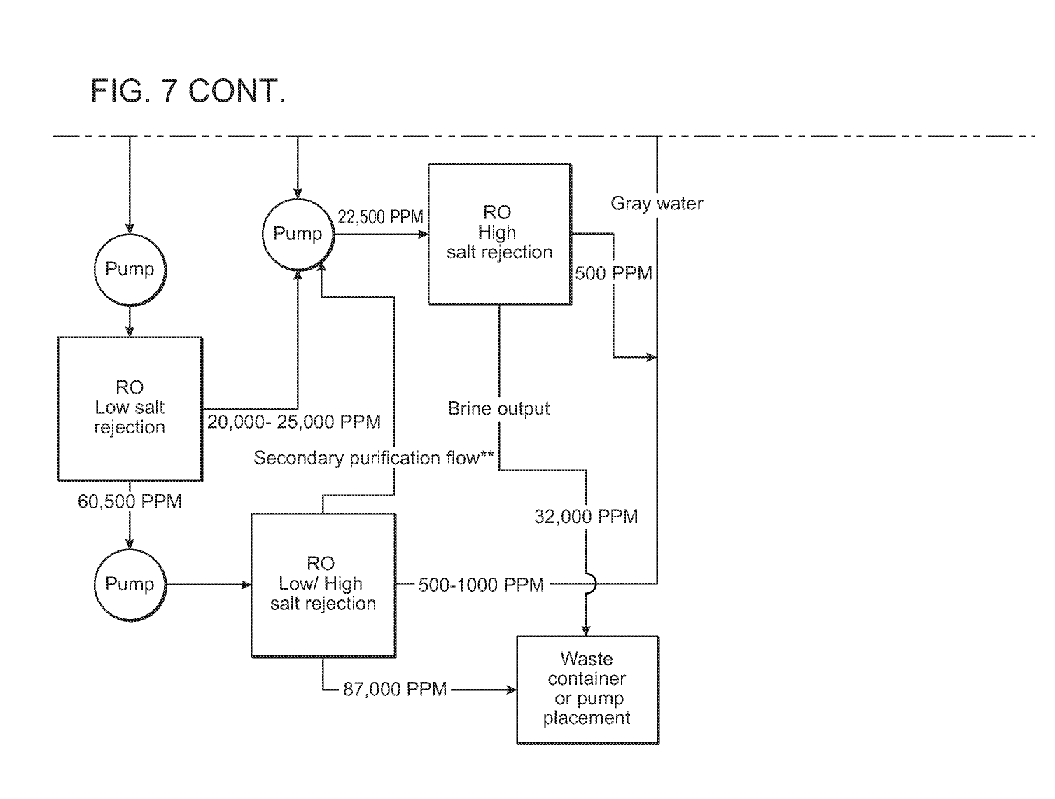

In one non-limiting example, the system 100 can include the following features with exemplary purification rates shown in FIG. 7.

Low salt rejection membranes in the first RO stage 8 are brackish water membranes that have purification range of 2,000-15,000 PPM. If their range is exceeded, e.g., 50,000 PPM, the membranes cannot block higher amounts of salts which pass through to the permeate side of the membrane. This bleed through effect is based on pressure and feed PPM concentration. Controlling this allows the system to use membranes as a contamination concentration switch. This lets the system have direct control over contamination levels in each stage by increasing or decreasing pressure if the feed concentration stays constant.

High rejection membranes for the second RO stage 9 are membranes built for salt or brine water. These membranes block 95% of all salts at higher ranges.

One non-limiting example of a brackish membrane is the DOW FILMTEC HRLE-440i membrane. One non-limiting example of a salt membrane is the DOW FILMTEC SW30HRLE-440i membrane. Other suitable membranes are also possible.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments.

Additionally, elements and components described herein may be further divided into additional components or joined together to form fewer components for performing the same functions.

Accordingly, the foregoing description and attached drawings are by way of example only, and are not intended to be limiting.

1. A method of reducing contaminants and dissolved solids in wastewater, comprising the steps of:
receiving the wastewater from a wastewater source;
mixing, in a tank, the wastewater with a stream of water having a lower level of total dissolved solids than the wastewater to produce a stream of diluted wastewater;
processing the stream of diluted wastewater in series in multiple reverse osmosis stages including a first reverse osmosis stage and a second reverse osmosis stage,
wherein the first reverse osmosis stage produces a first brine stream and a first permeate stream, wherein the method further comprises outputting the first brine stream as waste when the first brine stream reaches a given concentration of total dissolved solids, and outputting the first permeate stream to the second reverse osmosis stage;
wherein the second reverse osmosis stage produces a second brine stream and a second permeate stream, wherein the method further comprises outputting a portion of the second permeate stream to the tank to dilute additional wastewater to be processed and outputting the remainder of the second permeate stream as permeate, and outputting the second brine stream to the tank to be mixed with the additional wastewater.

2. The method of claim 1, further comprising storing the second brine stream to be used for diluting the wastewater in a secondary tank.

3. The method of claim 1, further comprising controlling the maximum total dissolved solids concentration in the diluted wastewater stream.

4. The method of claim 1, further monitoring liquid flow and adjusting system parameters to improve operational efficiency, the system parameters including at least one of liquid pressure, flow rate, conductivity, permeate flux, and brine build up.

5. The method of claim 1, wherein the permeate comprises potable water and the wastewater has a TDS concentration above 45,000 PPM.

6. The method of claim 1, wherein the wastewater is wastewater from a hydraulic fracturing operation.

7. The method of claim 1, wherein the wastewater comprises high salinity wastewater, lechate wastewater from landfills, industrial non-radiologic high toxicity wastewater, wastewater from coal or potash extraction, septic/sewage wastewater, wastewater produced from mining operations, wastewater produced from oil and/or gas extraction processes, or wastewater produced from pharmaceutical and industrial processes.

8. The method of claim 1, further comprising controlling the concentration of total dissolved solids in the first brine stream and/or the second permeate stream.

9. The method of claim 1, further comprising extracting desired elements from the first brine stream output as waste.

10. A system for reducing contaminants and dissolved solids in wastewater, comprising:
a tank for receiving the wastewater from a wastewater source and mixing the wastewater with a stream of water having a lower level of total dissolved solids than the wastewater to produce a stream of diluted wastewater;
multiple reverse osmosis stages for processing the stream of diluted wastewater including a first reverse osmosis stage connected in series to a second reverse osmosis stage, wherein the first reverse osmosis stage produces a first brine stream and a first permeate stream, wherein the first brine stream is output as waste when the first brine stream reaches a given concentration of total dissolved solids, and wherein the first permeate stream is output to the second reverse osmosis stage;
wherein the second reverse osmosis stage produces a second brine stream and a second permeate stream, wherein a portion of the second permeate stream is provided to the tank to dilute additional wastewater to be processed and the remainder of the second permeate stream is output as permeate, and wherein the second brine stream is provided to the tank to be mixed with the additional wastewater;
connection lines for operably connecting the tank and the reverse osmosis stages; and
a pump system for pumping liquid streams among the tank, the first reverse osmosis stage, and the second reverse osmosis stage.

11. The system of claim 10, further comprising a secondary tank for storing the second brine stream to be used for diluting the wastewater in the tank.

12. The system of claim 10, further comprising a control system for flow monitoring and adjusting system parameters to improve operational efficiency, the system parameters including at least one of liquid pressure, flow rate, conductivity, permeate flux, and brine build up.

13. The system of claim 12, wherein the control system is configured to display system information to a user and to enable manual input for parameter changes.

14. The system of claim 10, further comprising a control system for controlling the concentration of total dissolved solids in the first brine stream and/or the second permeate stream.

15. The system of claim 10, wherein the permeate comprises potable water and the wastewater has a TDS concentration above 45,000 PPM.

16. The system of claim 10, wherein the wastewater is wastewater from a hydraulic fracturing operation.

17. The system of claim 10, wherein the wastewater comprises high salinity wastewater, lechate wastewater from landfills, industrial non-radiologic high toxicity wastewater, wastewater from coal or potash extraction, septic/sewage wastewater, wastewater produced from mining operations, wastewater produced from oil and/or gas extraction processes, or wastewater produced from pharmaceutical and industrial processes.

18. The system of claim 10, further comprising an apparatus for extracting desired elements from the first brine stream output as waste.
